(19) United States
(12) Patent Application Publication
(10) Pub. No.: US 2025/0051880 A1
(43) Pub. Date: Feb. 13, 2025

(54) METHOD FOR PRODUCING REFINED ALUMINUM ALLOY

(71) Applicant: HONDA MOTOR CO., LTD., Tokyo (JP)

(72) Inventors: Yasushi MASHIYAMA, Saitama (JP); Ryo WAKABAYASHI, Saitama (JP)

(21) Appl. No.: 18/764,382

(22) Filed: Jul. 5, 2024

(30) Foreign Application Priority Data
Aug. 7, 2023 (JP) 2023-128490

(51) Int. Cl. C22C 1/02

(52) U.S. Cl. CPC C22C 1/026

(57) ABSTRACT

A method for producing a refined aluminum alloy according to an embodiment of the present invention includes a first heating step of heating a starting material of an aluminum alloy alone at a heating temperature at or above a liquidus temperature of the aluminum alloy to obtain a liquid melt, a cooling step of cooling the liquid melt at a cooling temperature below the liquidus temperature and at or above a solidus temperature of the aluminum alloy and producing aluminum alloy particles and sludge to obtain a semi-coagulated melt, a second heating step of heating the semi-coagulated melt at a heating temperature at or above the liquidus temperature and at or below a dissolution temperature of the sludge to melt the aluminum alloy particles, thereby producing a refined liquid melt to obtain a sludge-containing liquid melt, and a recovery step of recovering the refined liquid melt.

This application is based on and claims the benefit of priority from Japanese Patent Application No. 2023-128490, filed on Aug. 7, 2023, the content of which is incorporated herein by reference.

### BACKGROUND OF THE INVENTION

### Field of the Invention

The present invention relates to a method for producing a refined aluminum alloy.

### Related Art

Aluminum alloys containing metal elements such as silicon and copper added to aluminum are used for various industrial products. Meanwhile, aluminum alloys are widely recovered and recycled from scrapped aluminum alloy products. When aluminum alloys are recovered from scrapped aluminum alloy products, the scrapped aluminum alloy products are generally heated to provide melts of aluminum alloys. The melts of aluminum alloys may contain contaminated metals integrated therein resulting from metal fixtures such as screws and rivets used for the aluminum alloy products and metals adhered during use of the aluminum alloy products. Because of this, various studies have been carried out to investigate a manner for removing a contaminant metal element other than an alloy metal element added to an aluminum alloy from a melt of the aluminum alloy.

It has been known that iron contaminating an aluminum alloy can be removed by melting an iron/manganese-containing material and an aluminum alloy to obtain a melt, cooling the obtained melt to deposit an iron compound and removing the deposited iron compound (see Patent Document 1). It is also known that aluminum is recovered by bringing a coolant into contact with a melt of an aluminum alloy and cooling the melt to deposit an intermetallic compound of an impurity in the melt, precipitating the deposited intermetallic compound by gravity and allowing solidification and growth of a refined aluminum solid phase on the surface of the coolant (see Patent Document 2).
Patent Document 1: Japanese Unexamined Patent Application, Publication No. 2020-111808
Patent Document 2: Japanese Patent No. 3250256

### SUMMARY OF THE INVENTION

When an aluminum alloy recovered from a scrapped aluminum alloy product is used to reproduce an aluminum alloy product, it is desirable that the recovered aluminum alloy has a composition equivalent to the aluminum alloy used in an aluminum alloy product before use. Namely, when an aluminum alloy is recovered from a scrapped aluminum alloy product, it is desirable that only an aluminum compound containing a contaminant metal element is selectively removed from a melt of the scrapped aluminum alloy product. However, in the manner where the iron/manganese-containing material is used, there is a risk that the iron/manganese-containing material remains in the aluminum alloy. In addition, in the manner where the refined aluminum solid phase is solidified and grown on the surface of the coolant, aluminum having a high melting point is prone to solidify on the surface of the coolant, making it difficult to obtain an aluminum alloy containing an alloy metal element.

An object of the present invention is to provide a method for producing a refined aluminum alloy that can industrially advantageously produce a refined aluminum alloy having a low amount of contaminant metal element despite using a scrapped aluminum alloy product as a starting material and having a composition equivalent to the aluminum alloy used in the aluminum alloy product.

The inventors of the present invention found that the above problem can be solved by cooling a melt of an aluminum alloy containing a contaminant metal element to produce aluminum alloy particles and sludge in the melt and obtain a semi-solidified melt, heating the obtained semi-solidified melt to melt the aluminum alloy particles without dissolving the sludge and then separating a liquid melt from the sludge. Thus, the present invention has been achieved. The present invention therefore provides the following.

A first aspect of the present disclosure relates to a method for producing a refined aluminum alloy, including a first heating step of heating a starting material of an aluminum alloy alone at a heating temperature at or above a liquidus temperature of the aluminum alloy to obtain a liquid melt, a cooling step of cooling the liquid melt at a cooling temperature below the liquidus temperature and at or above a solidus temperature of the aluminum alloy and producing aluminum alloy particles and sludge to obtain a semi-solidified melt, a second heating step of heating the semi-solidified melt at a heating temperature at or above the liquidus temperature and at or below a dissolution temperature of the sludge to melt the aluminum alloy particles, thereby producing a refined liquid melt to obtain a sludge-containing liquid melt and a recovery step of separating the sludge from the refined liquid melt in the sludge-containing liquid melt and recovering the refined liquid melt.

In the method for producing a refined aluminum alloy of the first aspect, the starting material of the aluminum alloy alone is heated in the first heating step, and thus foreign materials hardly contaminate the liquid melt to be obtained. In addition, an aluminum alloy impurity containing a contaminant metal element in the starting material of the aluminum alloy forms the solid sludge in the cooling step and is separated from the melt of the aluminum alloy in the recovery step. Further, an additive for removing a contaminant metal element in the starting material of the aluminum alloy is not required. Because of the above, the method for producing the refined aluminum alloy of the first aspect can industrially advantageously produce, despite using a scrapped aluminum alloy product as the starting material of the aluminum alloy, a refined aluminum alloy having a composition equivalent to the aluminum alloy used in the aluminum alloy product, and the obtained refined aluminum alloy can be advantageously used for a starting material of the aluminum alloy product.

A second aspect of the present disclosure relates to the method for producing the refined aluminum alloy as described in the first aspect, in which a content of the aluminum alloy particles in the semi-solidified melt obtained in the cooling step is in the range of 10-90% by mass.

According to the method for producing the refined aluminum alloy of the second aspect, because a content of the aluminum alloy particles in the semi-solidified melt obtained in the cooling step is within the above range, the aluminum alloy impurity can be more securely and efficiently produced as the sludge. Because of the above, the obtained refined aluminum alloy has a composition closer to the aluminum alloy used in the aluminum alloy product.

A third aspect of the present disclosure relates to the method for producing the refined aluminum alloy as described in the first or second aspect, in which the cooling temperature in the cooling step is in the range of a temperature 40° C. lower than the liquidus temperature or above and a temperature 19° C. lower than the liquidus temperature or below.

According to the method for producing the refined aluminum alloy of the third aspect, because the cooling temperature in the cooling step is within the above range, the aluminum alloy impurity can be still more securely and efficiently deposited as the sludge. Because of the above, the obtained refined aluminum alloy has a composition further closer to the aluminum alloy used in the aluminum alloy product.

A fourth aspect of the present disclosure relates to the method for producing the refined aluminum alloy as described in any one of the first to third aspects, in which the heating temperature in the second heating step is in the range of a temperature 1° C. higher than the liquidus temperature or above and a temperature 129° C. higher than the liquidus temperature or below.

According to the method for producing the refined aluminum alloy of the fourth aspect, because the heating temperature in the second heating step is within the above range, the aluminum alloy particles can be melted without dissolving the sludge. Because of the above, the obtained refined aluminum alloy has a composition further closer to the aluminum alloy used in the aluminum alloy product.

A fifth aspect of the present disclosure relates to the method for producing the refined aluminum alloy as described in any one of the first to fourth aspects, in which in the second heating step, the sludge-containing liquid melt is left to stand to sediment the sludge in the refined liquid melt.

According to the method for producing the refined aluminum alloy of the fifth aspect, because the sludge is sedimented in the refined liquid melt in the second heating step, the sludge can be more securely separated from the refined liquid melt in the recovery step. Because of the above, the obtained refined aluminum alloy has a composition further closer to the aluminum alloy used in the aluminum alloy product.

A sixth aspect of the method for producing the refined aluminum alloy as described in any one of the first to fifth aspects, in which the starting material of the aluminum alloy is a scrapped aluminum alloy product.

According to the method for producing the refined aluminum alloy of the sixth aspect, because the scrapped aluminum alloy product is used as the starting material of the aluminum alloy, resources can be efficiently used and pressure on the environment can be reduced.

The present invention can provide a method for producing a refined aluminum alloy that can industrially advantageously produce a refined aluminum alloy having a low amount of contaminant metal element despite using a scrapped aluminum alloy product as a starting material and having a composition equivalent to the aluminum alloy used in the aluminum alloy product.

### BRIEF DESCRIPTION OF THE DRAWINGS

FIG. 1 is a flow chart illustrating the method for producing a refined aluminum alloy according to one embodiment of the present invention;

FIG. 2 is a conceptual view illustrating the cooling step in a method for producing a refined aluminum alloy according to one embodiment of the present invention; and

FIG. 3 is a conceptual view illustrating a second heating step in the method for producing a refined aluminum alloy according to one embodiment of the present invention.

### DETAILED DESCRIPTION OF THE INVENTION

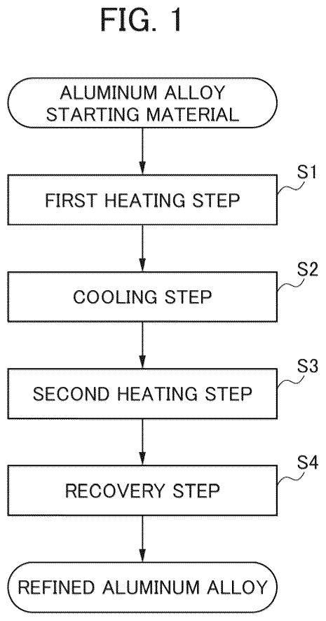

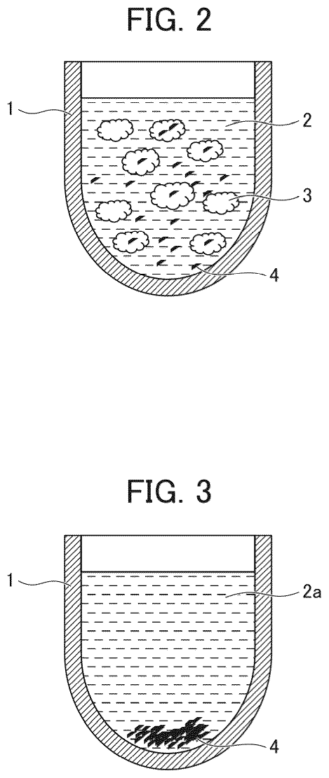

Embodiments of the present invention are hereinafter described by referring to the drawings. FIG. 1 is a flow chart illustrating the method for producing a refined aluminum alloy according to one embodiment of the present invention. FIG. 2 is a conceptual view illustrating a cooling step and FIG. 3 is a conceptual view illustrating a second heating step in the method for producing a refined aluminum alloy according to one embodiment of the present invention.

As illustrated in FIG. 1, the method for producing a refined aluminum alloy according to the present embodiment includes a first heating step S1, a cooling step S2, a second heating step S3 and a recovery step S4.

In the method for producing the refined aluminum alloy of the present embodiment, an aluminum alloy starting material used may be a scrapped aluminum alloy product. An aluminum alloy is an alloy containing an alloy metal element added to aluminum. Examples of the alloy metal element may include copper, silicon, magnesium, manganese and zinc. Examples of the aluminum alloy product may include cast materials, forged materials and wrought materials. Cast materials may include die cast materials. Any aluminum alloys may be used without limitation in terms of the type thereof, and examples of the aluminum alloy may include Al—Cu alloys, Al—Si alloys, Al—Mg alloys, Al—Mn alloys, Al—Cu—Si alloys, Al—Mg—Si alloys and Al—Zn—Mg alloys. Examples of the aluminum alloy starting material may include ADC1, ADC3, ADC5, ADC6, ADC10, ADC10Z, ADC12, ADC12Z and ADC14. The aluminum alloy starting materials may be used alone or in combination of two or more.

The first heating step S1 is a step of heating the aluminum alloy starting material alone at a heating temperature at or above a liquidus temperature to obtain a liquid melt. Any temperature at or above the liquidus temperature of the aluminum alloy may be used without limitation as the heating temperature of the aluminum alloy starting material in the first heating step S1. For example, when the aluminum alloy starting material is ADC12 (liquidus temperature: 610° C.), the heating temperature may be at or above 610° C.

Any heating devices may be used without limitation when heating the aluminum alloy starting material and well-known devices that are used as a melting furnace of aluminum alloys such as rotary furnace may be used.

The cooling step S2 is a step of cooling the liquid melt at a cooling temperature below the liquidus temperature and at or above a solidus temperature and producing aluminum alloy particles and sludge to obtain a semi-solidified melt.

As illustrated in FIG. 2, when the liquid melt 2 in the heating device 1 is cooled to a temperature below the liquidus temperature in the cooling step S2, aluminum alloy particles 3 containing an alloy metal element are produced. Because of production of the aluminum alloy particles 3, the amount of the aluminum alloy in the liquid melt 2 decreases and the concentration of an aluminum alloy impurity containing a contaminant metal element is relatively increased. The aluminum alloy impurity is, for example, an intermetallic compound containing a contaminant metal element and aluminum. When the concentration of the aluminum alloy impurity in the liquid melt 2 increases, the aluminum alloy impurity is deposited and a sludge 4 is produced. The liquid melt may be cooled while stirring the liquid melt 2 or without stirring. Examples of the contaminant metal element may include iron, chromium, nickel and silicon.

The cooling temperature in the cooling step S2 may be in the range of, for example, a temperature 40° C. lower than the liquidus temperature or above and a temperature 19° C. lower than the liquidus temperature or below. For example, when the aluminum alloy starting material is ADC12, the cooling temperature may be in the range of 570-591° C. The cooling may be carried out over any period of time without limitation, and the cooling time may be, for example, 30 minutes or more.

The semi-solidified melt obtained in the cooling step S2 may have a content of the aluminum alloy particles 3 in the range of, for example, 10-90% by mass. The content of the aluminum alloy particles 3 can be calculated from the liquidus temperature and the solidus temperature in the phase equilibrium diagram of the aluminum alloy and the cooling temperature.

The second heating step S3 is a step of heating the semi-solidified melt at a heating temperature at or above the liquidus temperature and at or below a dissolution temperature of the sludge to melt the aluminum alloy particles without dissolving the sludge, thereby obtaining a sludge-containing liquid melt.

As illustrated in FIG. 3, the semi-solidified melt obtained in the cooling step S2 is heated at or above the liquidus temperature in the second heating step S3, and thus the aluminum alloy particles free from the aluminum alloy impurity are melted and a refined liquid melt 2a is produced. As the heating temperature is a temperature at or below the dissolution temperature of the sludge 4, the sludge 4 is hardly dissolved in the refined liquid melt 2a. The semi-solidified melt may be heated while stirring the semi-solidified melt or without stirring. In the second heating step S3, the refined liquid melt 2a containing the sludge 4 may be left to stand to sediment the sludge 4 at the bottom of the heating device 1.

The heating temperature in the second heating step may be, for example, in the range of a temperature 1° C. higher than the liquidus temperature or above and a temperature 129° C. higher than the liquidus temperature or below. For example, when the aluminum alloy starting material is ADC12 and the sludge is an intermetallic compound containing iron and aluminum, the heating temperature may be in the range of 611-739° C. The heating may be carried out over any period of time without limitation, and the heating time may be, for example, 30 minutes or more.

The recovery step S4 is a step of separating the sludge from the refined liquid melt in the sludge-containing liquid melt and recovering the refined liquid melt. The refined liquid melt may be recovered by any manner without limitation, and various solid-liquid separation methods such as filtration, decantation and centrifugation may be used.

The refined liquid melt recovered in the recovery step S4 may be solidified once to obtain an aluminum alloy ingot. Alternatively, the refined liquid melt may be directly used for a starting material for a cast material, a forged material or a wrought material. Further, an alloy metal element may be optionally added to the refined liquid melt.

In the method for producing a refined aluminum alloy of the present embodiment as above, the starting material of the aluminum alloy alone is heated in the first heating step S1, and thus foreign materials hardly contaminate the liquid melt to be obtained. In addition, the aluminum alloy impurity containing a contaminant metal element in the aluminum alloy starting material forms the solid sludge in the cooling step S2 and is separated from the melt of the aluminum alloy in the recovery step S4. Further, an additive for removing the contaminant metal element in the starting material of the aluminum alloy is not required. Because of the above, the method for producing the refined aluminum alloy of the present embodiment can industrially advantageously produce a refined aluminum alloy having a composition equivalent to the aluminum alloy used in a scrapped aluminum alloy product used as the aluminum alloy starting material, and the obtained refined aluminum alloy can be advantageously used for a starting material of the aluminum alloy product.

When the semi-coagulated melt obtained in the cooling step S2 has a content of the aluminum alloy particles within the above range in the method for producing the refined aluminum alloy according to the present embodiment, the aluminum alloy impurity can be more securely and efficiently produced as the sludge. Because of the above, the obtained refined aluminum alloy has a composition closer to the aluminum alloy used in the aluminum alloy product. When the cooling temperature in the cooling step S2 is within the above range, the aluminum alloy impurity can be still more securely and efficiently deposited as the sludge. Because of the above, the obtained refined aluminum alloy has a composition further closer to the aluminum alloy used in the aluminum alloy product.

When the heating temperature in the second heating step S3 is within the above range in the method for producing the refined aluminum alloy according to the present embodiment, the aluminum alloy particles can be melted without dissolving the sludge. Because of the above, the obtained refined aluminum alloy has a composition further closer to the aluminum alloy used in the aluminum alloy product. When the sludge-containing liquid melt is left to stand to sediment the sludge in the refined liquid melt in the second heating step S3, the sludge can be more securely separated from the refined liquid melt in the recovery step. Because of the above, the obtained refined aluminum alloy has a composition further closer to the aluminum alloy used in the aluminum alloy product.

Because a scrapped aluminum alloy product is used as the aluminum alloy starting material in the method for producing the refined aluminum alloy according to the present embodiment, resources can be efficiently used and thus pressure on the environment can be reduced.

The embodiments of the present invention have been described hereinabove. The present invention is not limited to the above embodiments and the embodiments may be modified, as appropriate, within the scope of the present invention. For example, although a scrapped aluminum alloy product is used as the aluminum alloy starting material in the present embodiment, any aluminum alloy starting materials may be used. The aluminum alloy starting material used may be a starting material mixture containing metallic aluminum and an alloy metal element. Examples of the alloy metal element may include copper, silicon, magnesium, manganese and zinc. In this case, impurities in metallic aluminum and an alloy metal element can be removed as the sludge.

### EXAMPLES

### Example 1

A scrapped aluminum alloy die cast product (ADC12, liquidus temperature: 610° C.) was prepared as the aluminum alloy starting material. The prepared ADC12 was placed in a rotary furnace and heated at 650° C. to obtain a liquid melt (first heating step). A fraction of the obtained liquid melt was solidified and analyzed for the composition. The results are indicated in Table 1 below as the composition of the scrapped aluminum alloy. Table 1 also indicates the composition of components in aluminum alloy of the aluminum alloy die cast product before use as the composition of aluminum alloy before use.

The liquid melt was then cooled at 580° C. for 30 minutes while being left to stand to obtain a semi-solidified melt containing aluminum alloy particles and sludge (cooling step). The semi-solidified melt had a content of the aluminum alloy particles calculated from the liquidus temperature and the solidus temperature in the phase equilibrium diagram of the aluminum alloy and the cooling temperature (580° C.) of the liquid melt of 63% by mass.

The semi-solidified melt was then heated at 620° C. for 30 minutes while being left to stand to melt the aluminum alloy particles (second heating step). The obtained liquid melt had sludge sedimented at the bottom thereof. The liquid melt and the sludge were then respectively recovered from the rotary furnace (recovery step). The results of analysis of the composition of the recovered sludge found that the sludge was an intermetallic compound containing iron and aluminum. The dissolution temperature of the sludge was 740° C. The dissolution temperature of the sludge was measured as follows. Sludge was placed in a heat resistant container with a thermocouple and the container was placed in an electric furnace. The sludge was then heated while measuring the temperature of the sludge with the thermocouple. The temperature at which the sludge melted is considered to be the dissolution temperature.

The recovered liquid melt was allowed to cool to obtain an aluminum alloy. The obtained aluminum alloy had a yield of 96%. A portion of the obtained aluminum alloy was sampled and its composition analyzed. The results are indicated in Table 1 below as the content of components in refined aluminum alloy. Table 1 also indicates the amount of change in contents of components calculated from formula (1) below and the percentage change in contents of components calculated from formula (2) below. Formula (1): Amount (% by mass) of change in content of component=content (% by mass) of component in refined aluminum alloy−content (% by mass) of component in scrapped aluminum alloy

$$Percentage ( \% ) change in content of component = \qquad Formula ( 2 )$$

$$[ content ( \% by mass ) of component in refined aluminum alloy -$$

$$content ( \% by mass ) of component in scrapped aluminum alloy ] /$$

$$content ( \% by mass ) of component in aluminum alloy before use \times 100$$

TABLE 1

| | Component | | | | | | |
|---|---|---|---|---|---|---|---|
| | Cu | Si | Mg | Zn | Fe | Mn | Cr |
| Content of component in | 1.83 | 9.54 | 0.19 | 0.751 | 0.83 | 0.081 | 0.012 |
| aluminum alloy before use | | | | | | | |
| (% by mass) | | | | | | | |
| Content of component in | 1.80 | 9.41 | 0.188 | 0.768 | 1.829 | 0.092 | 0.016 |
| scrapped aluminum alloy | | | | | | | |
| (% by mass) | | | | | | | |
| Content of component in | 1.85 | 9.55 | 0.175 | 0.737 | 1.020 | 0.066 | 0.009 |
| refined aluminum alloy | | | | | | | |
| (% by mass) | | | | | | | |
| Amount of change in | 0.05 | 0.14 | −0.013 | −0.031 | −0.809 | −0.026 | −0.007 |
| content of component | | | | | | | |
| (% by mass) | | | | | | | |
| Percentage change in | 2.8 | 1.5 | −6.9 | −4.0 | −44.2 | −28.3 | −43.8 |
| content of component | | | | | | | |
| (%) | | | | | | | |

From the amounts of change in contents of components in Table 1, it was found that Example 1 could significantly reduce contents of transition metals such as iron, manganese and chromium without significantly changing contents of copper and silicon which are major alloy metal elements of ADC12. From the percentage change in contents of components, it was found that the obtained refined aluminum alloy had a composition equivalent to the aluminum alloy before use.

### EXPLANATION OF REFERENCE NUMERALS

1 Heating device
2 Liquid melt
2a Refined liquid melt
3 Aluminum alloy particles
4 Sludge

What is claimed is:

1. A method for producing a refined aluminum alloy, comprising a first heating step of heating a starting material of an aluminum alloy alone at a heating temperature at or above a liquidus temperature of the aluminum alloy to obtain a liquid melt,
a cooling step of cooling the liquid melt at a cooling temperature below the liquidus temperature and at or above a solidus temperature of the aluminum alloy and producing aluminum alloy particles and sludge to obtain a semi-solidified melt,
a second heating step of heating the semi-solidified melt at a heating temperature at or above the liquidus temperature and at or below a dissolution temperature of the sludge to melt the aluminum alloy particles, thereby producing a refined liquid melt to obtain a sludge-containing liquid melt, and
a recovery step of separating the sludge from the refined liquid melt in the sludge-containing liquid melt and recovering the refined liquid melt.

2. The method for producing the refined aluminum alloy according to claim 1, wherein a content of the aluminum alloy particles in the semi-solidified melt obtained in the cooling step is in the range of 10-90% by mass.

3. The method for producing the refined aluminum alloy according to claim 1, wherein the cooling temperature in the cooling step is in the range of a temperature 40° C. lower than the liquidus temperature or above and a temperature 19° C. lower than the liquidus temperature or below.

4. The method for producing the refined aluminum alloy according to claim 1, wherein the heating temperature in the second heating step is in the range of a temperature 1° C. higher than the liquidus temperature or above and a temperature 129° C. higher than the liquidus temperature or below.

5. The method for producing the refined aluminum alloy according to claim 1, wherein in the second heating step, the sludge-containing liquid melt is left to stand to sediment the sludge in the refined liquid melt.

6. The method for producing the refined aluminum alloy according to claim 1, wherein the starting material of the aluminum alloy is a scrapped aluminum alloy product.
